(19) United States
(12) Patent Application Publication
(10) Pub. No.: US 2002/0026473 A1
(43) Pub. Date: Feb. 28, 2002

(54) Application-programming-interface-based method and system including triggers

(75) Inventor: Christophe Gourraud, Montreal (CA)

Correspondence Address: ANDRE M. SZUWALSKI, Jenkens & Gilchrist, P.C., 1445 Ross Avenue, Dallas, TX, 75202-2799, US

(73) Assignee: Telefonaktiebolaget LM Ericsson (publ)

(21) Appl. No.: 09/841,232

(22) Filed: Apr. 23, 2001

Related U.S. Application Data
(60) Provisional application No. 60/229,430, filed on Aug. 31, 2000.

(51) Int. Cl. G06F 15/16

(52) U.S. Cl. 709/203; 709/318

(57) ABSTRACT

Application-programming-interface(API) based triggers are included in an API-based system. Information about users associated with specific triggers in a user profile database is downloaded for use during calls. Upon occurrence of pre-determined events during the calls, triggers are sent to a service manager. The service manager performs service interaction management in response to the triggers. The trigger information is cached by the service manager in order to minimize network traffic. If no service interaction management is necessary, applications communicate directly with network entities such as, for example, call servers. If service interaction management is necessary, the service manager serves as a proxy between the applications and the network entities.

### BACKGROUND

In connection with phenomenal growth in popularity of the Internet, there has been a tremendous interest in use of packet-switched network infrastructures (e.g., Internet Protocol (IP) based networks) as a replacement for, or as an adjunct to, existing circuit-switched network infrastructures that are used in today's telephony. From a network operator's perspective, traffic aggregation that is inherent in packet-switched infrastructures allows for a reduction in costs of transmission and infrastructure cost per end user. Such cost reductions ultimately enable the network operator to pass on the concomitant cost savings to end users.

Packet-switched technologies also allow a network operator to offer new services not available via circuit-switched technologies. Existing circuit-switched technologies, such as, for example, Intelligent Networking (IN), Advanced Intelligent Networking (AIN), Wireless Intelligent Networking (WIN), and Customized Application of Mobile Enhanced Logic (CAMEL) have been used mainly for voice telephony and are viewed as having relatively limited functionality compared to packet-switched, IP-based networks. Therefore, these circuit-switched technologies are expected to be phased out over time in favor of packet-switched technologies.

As is well known in the telecommunications industry, services and service provisioning are a major reason for the existence of telecommunications networks. Services are typically categorized into: (1) basic services (i.e., services that allow basic call processes such as call establishment and termination); and (2) advanced services, such as multi-media and data services. It is also well known that advanced services operate as factors for market differentiation and are crucial for the success of a network operator and a service provider.

IP multimedia (IPMM) is an example of an advanced service. IPMM is an IP-based service that provides synchronized data streams between end points via the Internet. IPMM allows provisioning of integrated voice, data, video, traditional call conferencing, call control supplementary measures, multimedia transport, and mobility, as well as services that integrate web, email, presence and instant messaging applications with telephony.

The emergence of packet-switched technologies has resulted in the potential for convergence among disparate technologies such as circuit-switched telecommunication networks (e.g., cellular networks), advanced information technology (e.g., Application Programming Interfaces (APIs) and Common Object Request Broker Architecture (CORBA)), and Internet-based technologies (e.g., hypertext transfer protocol, hypertext mark-up language/eXtensible mark-up language, and Java servlets). However, there is particular concern regarding how the different technologies will interact with one another.

One approach to integrating these disparate technologies is known as Parlay. Parlay is a set of object-oriented APIs that have been developed by an industry consortium of telecommunications companies and information technology companies known as the Parlay Group. It is hoped that Parlay will permit a combination of IP-based application development resources with the extensive capabilities of telecommunications networks. One of Parlay's objectives is to facilitate development of API-based applications across wireless networks, IP-based networks, and circuit-switched networks such as the Public Switched Telephone Network (PSTN). The Parlay APIs have been developed to provide a common open interface into various types of telecommunications networks and to promote interworking of packet-switched networks and circuit-switched networks. Parlay aims to permit controlled access to various kinds of telecommunications networks in order to permit creation of a wide range of new services, such as, for example, IPMM applications.

The Parlay APIs are designed to permit network operators to allow controlled access to network resources by parties outside the network, who are referred to as third-party service providers. Third-party service providers are typically information technology companies that do not have intimate knowledge of telecommunications or the operation of telecommunications networks. Applications outside a telecommunications network can use the Parlay APIs to access and direct network resources to perform specific actions or functions.

This type of access was previously available only to telecommunications network operators. Therefore, any time a new service was to be implemented, detailed technical and operational involvement of the network operators themselves was necessitated. In contrast, the Parlay APIs aim to allow new services, including third-party applications, to be developed without requiring intimate knowledge of the internal operation of the telecommunications networks on the part of the third-party service providers.

While one of the goals of the Parlay Group is to enable a new generation of off-the-shelf network applications and components to be developed by third-party service providers independently of the underlying networks, the complexity of the Parlay APIs renders them, in actuality, better suited for applications developed by telecommunications companies as opposed to third-party service providers. Parlay reuses many IN concepts, because it was initially defined by telecommunications companies. For example, the Parlay APIs currently require third-party service providers to be familiar with the IN call model and to understand operation of IN detection points. Many third-party service providers have been hesitant to develop Parlay applications due to their lack of familiarity with telecommunications networks and protocols.

Open Service Access (OSA), a version of Parlay developed by the Third Generation Partnership Project (3GPP), was introduced in the Universal Mobile Telecommunications System (UMTS) standardization. OSA is part of the Virtual Home Environment (VHE) and is often referred to as Parlay/OSA. Parlay/OSA was developed to be utilized in CAMEL-compatible wireless networks. Java APIs for Integrated Networks (JAIN) are application programming interfaces that are currently a competitor of Parlay. Efforts are ongoing to make Parlay and JAIN compatible with one another.

Parlay/OSA can be used as a complement to IN-based systems, such as, for example, CAMEL in Global System for Mobile communications (GSM) networks. Parlay/OSA is not currently used in GSM for the full scope of advanced services and relies in part on CAMEL-implemented mechanisms. However, because movement is taking place towards providing advanced services such as IPMM, Parlay/OSA might in the future completely support advanced service provisioning independently of CAMEL or other IN-based support.

Parlay (including Parlay/OSA) as currently defined has several drawbacks. The Parlay APIs are too complex for many third-party service providers, which complexity requires that the third-party service providers have intimate knowledge of the details of operation of telecommunications networks on which they want to deploy their applications. For example, the Parlay APIs as currently defined require that applications handle both service management and service execution issues. It would be preferable to unburden the third-party service providers with responsibility for service management issues and to let the telecommunications networks handle these duties.

In addition, Parlay is not well-adapted to subscription-based services (e.g., API-based interactions versus separate management tools). Therefore, each time a new user wants to subscribe to a service, an API is invoked, which is unduly cumbersome. Parlay is also not well suited to VHE service subscription, in which users subscribe with a home environment rather than with a third-party service provider. Moreover, too much control over the network is given to third-party service providers in the current implementation of Parlay, which is of concern to network operators and runs counter to the stated objectives of Parlay, in which third-party service provider applications are intended to be agnostic with respect to the details, such as the topology, of the network.

Parlay also fails to optimally support underlying technology independence. For example, if a given IN detection point does not exist in a particular version of IN (e.g., CAMEL), that version of IN and Parlay must be matched to account for this fact. This matching requirement gives third-party service providers too much information about and control over the network.

Even though a migration to packet-switched networks is ongoing, many network operators want to keep IN as their preferred solution for implementation of voice services in order to avoid incurring costs associated with a wholesale change from circuit-switched networks (e.g., IN-based networks) to packet-switched networks (e.g., IP-based networks). These operators are reluctant to invest in Parlay-based solutions, despite Parlay's enhanced functionality relative to IN. It would therefore be desirable if IN-based solutions were integrated with Parlay-based solutions so that a more gradual migration could take place. While Parlay/OSA is preferably the primary solution for advanced services, it would be advantageous for optimal advanced-service (e.g., IPMM) support to not be jeopardized by Parlay's support of IN. In contrast, other operators want to use Parlay for both voice and also for advanced services to the exclusion of IN. For these operators, Parlay must be able to provide all of the functionality of IN as well as the advanced services of packet-based networks.

Parlay/OSA as currently defined does not equal current IN capabilities, in large part due to its lack of triggers. As noted above, a gradual migration from IN to Parlay/OSA will be severely hindered if Parlay/OSA is not able to equal current IN capabilities.

Another drawback of Parlay is its failure to support service interaction management. The term service interaction management refers generally to interoperation of multiple applications. A very simple example of service interaction management would be if a mobile station user had subscribed to a call forwarding service and to a call barring service. Those persons having ordinary skill in the art will recognize that service interaction management can be much more complex than the example described below. In this example, the call barring service, which is resident on a first application, bars incoming calls from telephone numbers pre-selected by the mobile station user. The call forwarding service, which is resident on a second application, forwards incoming calls toward the mobile station to another telephone number selected by the user. If service interaction management is not supported, a situation could be envisioned in which the two applications would not work together as the user would want.

It would be expected that the user would not want to forward barred calls since barred calls are by definition calls that the user does not want to receive. Therefore, it would be desirable for incoming calls to be screened first to determine whether they are barred and then forwarded only if they have not been pre-selected by the user to be so barred.

Parlay's lack of support of service interaction management prevents two or more applications from subscribing to the same notification. A notification serves as notice to an application that a given event has occurred on the network. Therefore, in the example above, once either the call barring application or the call forwarding application has subscribed to a given notification, the other application cannot also subscribe to that notification.

Service interaction management is not supported by Parlay because, in Parlay, applications directly access detection points rather than a detection point leading to triggers that then lead to the applications, as in IN. Therefore, unlike IN, in which a single detection point can correspond to several triggers and a single trigger can correspond to several applications, there is, in Parlay, a one-to-one correspondence between an application and a detection point. Because there are no triggers in Parlay, when applications seize a detection point, all other applications are prohibited from seizing the same detection point.

In the above example, it was assumed that two different applications handled the call barring and call forwarding services, respectively. One solution to the service interaction management problem could be to place both applications within the same third-party-service-provider-developed application. However, this requirement runs counter to one of the stated goals of Parlay, which is to provide flexibility to third-party service providers to develop relatively simple applications. It also requires third-party service providers to know more about the intimate details of the networks'operations than is optimal. Moreover, because, in some situations, more than one service provider or developer might use the APIs, services created by different service providers could be subject to service interaction management concerns.

Service interaction management and execution of a service by an application require the application to be unduly complex. In other words, the application is required not only to implement the service but also to implement setting of conditions under which the service should be invoked. It would be preferable if the network were able to handle service interaction management issues and invoke applications as needed. With network-handled service interaction management, the application would only know that it has been invoked and would not be aware of conditions on the network that resulted in its invocation.

Another possibility to fix the call barring/call forwarding problem discussed above would be to allow the network to cheat by not providing to the call forwarding application a particular notification relevant to call forwarding to which it has subscribed if the network determines that call barring is applicable to the number of the incoming call. Such network cheating would ensure that call forwarding is not invoked. However, if the network is allowed to cheat in this manner, the freedom supposedly given to the application is artificial because the application's request to be notified is not being fulfilled. If network cheating is implemented as a solution to the service interaction management problem, the network operator must know a great deal about the application. This is obviously not ideal, given Parlay's goal of allowing third-party service provider applications to be implemented on the network without the network operator being intimately involved in operation of the applications.

In Parlay and OSA, gateways are used to permit third-party applications to have access to the capabilities of networks. These gateways can be either physical or logical, as described in more detail below. In Parlay, no mention of physical versus logical gateways is made. OSA states that either logical or physical gateways can be used. It appears to be a matter of choice; however, it is not really a choice, but rather depends upon how the APIs are defined.

Referring now to the FIGURES, FIG. 1 is a block diagram illustrating an exemplary architecture 100 that includes a physical gateway between a third-party domain 102 and public telecommunication network domains 106. The architecture 100 includes the third-party domain 102, a physical gateway 104, and the public network domains 106. The public network domains 106 comprise a plurality of network entities NE₁-NEₙ. The physical gateway 104 serves to provide open, non-discriminatory, and secure access to functionality of the public network domains 106. The public network domains 106 can include, for example, the Public Land Mobile Network (PLMN), Public Switched Telephone Network (PSTN), as well as Internet Protocol (IP) based networks. The physical gateway 104 provides a connection between the third-party domain 102 and the public network domains 106, including the network entities NE₁-NEₙ.

The physical gateway 104 is a specialized network entity that supports an application-programming interface, such as Parlay/OSA, and communicates with at least one network entity of the plurality of network entities NE₁-NEₙthat supports capabilities to be accessed by third-party applications resident on the third-party domain 102. Thus, a third-party application on the third-party domain 102 communicates with the physical gateway 104 via APIs 108 and the physical gateway 104 communicates via an interface 110 with at least one network entity of the plurality of entities NE₁-NEₙin the public network domains 106 in order to access capabilities of the network domains 106.

Neither Parlay nor OSA addresses what type of API or protocol should be used on the interface 110 for communications between the physical gateway 104 and the public network domains 106. Therefore, an intermediate application-programming interface or protocol on the interface 110 must be developed in order for communication between the physical gateway 104 and the public network domains 106 to occur.

The intermediate protocol or API on the interface 110 developed to permit the gateway 104 to communicate with the public network domains 106 prevents capabilities of the network entities NE₁-NEₙfrom being directly reflected on the application-programming interface 108 and possibly limits performance of the architecture 100 due to the use of mapping/translation. Also, the physical gateway 104 can prevent an operator of the domains 106 from utilizing the interface 108.

Another drawback of the physical gateway 104 is that, because two interfaces (i.e., the APIs 108 and the API or protocol on the interface 110) must be standardized, standardization is likely to be slower. In addition, it is very likely that the use of the intermediate protocol or API on the interface 110 can create a bottleneck in service between the gateway 104 and the public network domains 106.

It can thus be seen from FIG. 1 that the use of a physical gateway has several drawbacks associated with the necessity of a protocol or interface between the physical gateway and the public network domains to support the application-programming interface between the third-party domain and the gateway.

Referring again to the FIGURES, reference is now made to FIG. 2, wherein there is shown a block diagram illustrating an exemplary architecture including a logical gateway. An architecture 200 includes the third-party domain 102 and the public network domains 106. The domain 102 includes an application server 206 and an application server 208. The domains 106 include a call server 210, shown herein as a serving Call Service Control Function (CSCF), a logical gateway 212, a mobile station 214, and a user profile database 216. The gateway 212 is co-located with the call server 210 and is for that reason referred to as a logical gateway.

A logical gateway is defined herein as a gateway that is co-located with a network entity of the domains 106. In contrast with the physical gateway 104 of FIG. 1, because the gateway 212 is co-located with the call server 210, the gateway 212 does not need to use an intermediate API or protocol on the interface 110 to communicate with the call server 210. The gateway 212 communicates with the application server 208 via the application-programming interface 108 which can be, for example, Parlay or Parlay/OSA. In addition, the call server 210 communicates with the application server 206 via a networking protocol 220, such as, for example, CAMEL.

As used herein, the term application-programming interface refers to a set of operations that allows an application to access functionality in another application. Application-programming interfaces are defined using an object-oriented description language that can be used to map from one application to another. Examples of object-oriented description languages are Object Management Group Interface Description Language (OMG IDL) and MICROSOFT™ Interface Description Language (IDL). Parlay is defined in both OMG IDL and MICROSOFT™ IDL. OSA is defined only in OMG IDL. When viewed from a network perspective, application-programing interfaces must be transported by a semantic-free protocol. Examples of such protocols are common object request broker architecture internet inter-ORB protocol (CORBA IIOP) and HTTP/XML-based Simple Object Access Protocol (HTTP/XML-based SOAP).

As used herein, networking protocols are protocols that have very well-defined semantics, such as, for example, protocols used by CAMEL (CAP), WIN (IS-41) and IN (INAP). The messages and parameters of the foregoing networking protocols are defined to carry service control semantics. A primary difference between APIs and networking protocols is that, with networking protocols, the service control semantics are defined in the protocol itself, while in APIs, the service control semantics are defined at a higher level, in an interface description language that can be automatically mapped into APIs to be used by applications and transported by semantic-free protocols.

In FIG. 2, the application server 206 operates according to the networking protocol 220, which can be, for example, IN, WIN, or CAMEL. In contrast, the application server 208 operates according to the API 108, which can be, for example, Parlay, Parlay/OSA, or JAIN. Therefore, the gateway 212 can communicate with the application server 208 when applications utilizing the API 108 need to access the domains 106 and then can communicate directly with the call server 210 without a need for an intermediate API or protocol on the interface 110. The call server 210 communicates with the mobile station 214 via an interface Gm 222.

An advantage of the logical gateway 212 is that capabilities of the domains 106 can be directly reflected in the API 108 without any possibly limiting intermediate APIs or protocols, such as, for example, on the interface 110. In addition, in contrast to the physical gateway 104, faster standardization is possible because there is only one interface to standardize (i.e., the APIs 108). In addition, in contrast to the physical gateway 104, there is no potential bottleneck arising from the need for an additional protocol or API on the interface 110 between the gateway 212 and the call server 210.

Despite the advantages of the logical gateway 212, there are also disadvantages. In Parlay/OSA, if APIs, such as the APIs 108, correspond to capabilities that are supported by entities other than the entity with which the logical gateway 212 is co-located (i.e., the call server 210), it is impossible for the gateway 212 to be purely logical. This is because, if the APIs 108 desire to access capabilities on more than one network entity (e.g., network entities other than the call server 210), the network entity with which the gateway 212 is co-located would be required to communicate with these other network entities. Once a need arises for such communication between, for example, the call server 210 and the other network entity, such as, for example, the user profile database 216, the gateway 212 becomes, in effect, at least partially a physical gateway, because an intermediate API or protocol between the call server 210 and the user profile database 216 is needed. Therefore, the gateway 212 can be completely logical only if all of the capabilities sought by applications such as, for example, those residing on the application server 208 are supported by a single network entity with which the gateway is co-located.

Therefore, it can be seen from FIGS. 1 and 2 that, even though Parlay does not address the issue of a logical versus a physical gateway and OSA states that either a logical or a physical gateway is possible, the choice of a physical or logical gateway is not really a free choice. It can be seen that although logical gateways have advantages, such as the elimination of a need for an intermediate protocol, if an application needs to access capabilities from more than one network entity, a purely logical gateway is not possible. Physical gateways similarly have disadvantages.

There is accordingly a need for a method and system for enhanced-application-programming interface operation that solves some of the abovementioned problems and other problems associated with the prior art. There is, in particular, a need for a solution of the problems associated with Parlay/OSA's lack of support of service interaction management and of the problems surrounding convergence of Parlay with IN.

### SUMMARY

Some of the drawbacks of the prior art are overcome by the present invention, wherein a method of providing telecommunications services includes the steps of sending by a call server of a first trigger linked to a first call event to a service manager in response to occurrence of the first call event. The method also includes sending by the call server of a second trigger linked to a second call event to the service manager in response to occurrence of a second call event. In response to receipt of the first and the second triggers, the service manager performs a service interaction management analysis in determining which applications should be executed. In response to a determination that at least one application should be executed, the service manager invokes the at least one application via an application programming interface.

In another aspect of the present invention, an application programing interface (API) based telecommunication system includes a call server obtaining criteria corresponding to at least one trigger from a user profile database and, in response to occurrence of the criteria, sending the at least one trigger. A service manager receives the at least one trigger, and, in response to receipt of the at least one trigger, performs a service interaction management analysis in determining in what manner applications should be executed. An application programming interface is adapted to permit the call server, the service manager, and the applications to communicate. At least one application is invoked in response to a communication from the service manager via the application programming interface.

In another aspect of the present invention, a telecommunication system comprises a service node adapted to communicate according to predetermined criteria via an application programming interface with at least one application or via a networking protocol. At least one network entity is adapted to send to the service node a networking protocol trigger that includes an API requirement. The API requirement requests an API response to the trigger. The service node is adapted to respond, depending on the predetermined criteria, to the network entity according to the networking protocol or to communicate with the at least one application via the application programming interface.

According to another aspect of the present invention, a method of converging telecommunications systems comprises sending by at least one network entity to a service node a networking protocol trigger that includes an application programming interface requirement. The application programming interface requirement requests an API response to the trigger. Depending on predetermined criteria, the service node responds to the network entity according to the networking protocol or the service node communicates with at least one application or with the network entity via the API.

### BRIEF DESCRIPTION OF THE DRAWINGS

A more complete understanding of the present invention can be had by reference to the following Description when taken 'in conjunction with the accompanying Drawings, wherein:

FIG. 1, previously described, is a block diagram of an exemplary architecture that includes a physical gateway between a third-party domain and public telecommunication network domains;

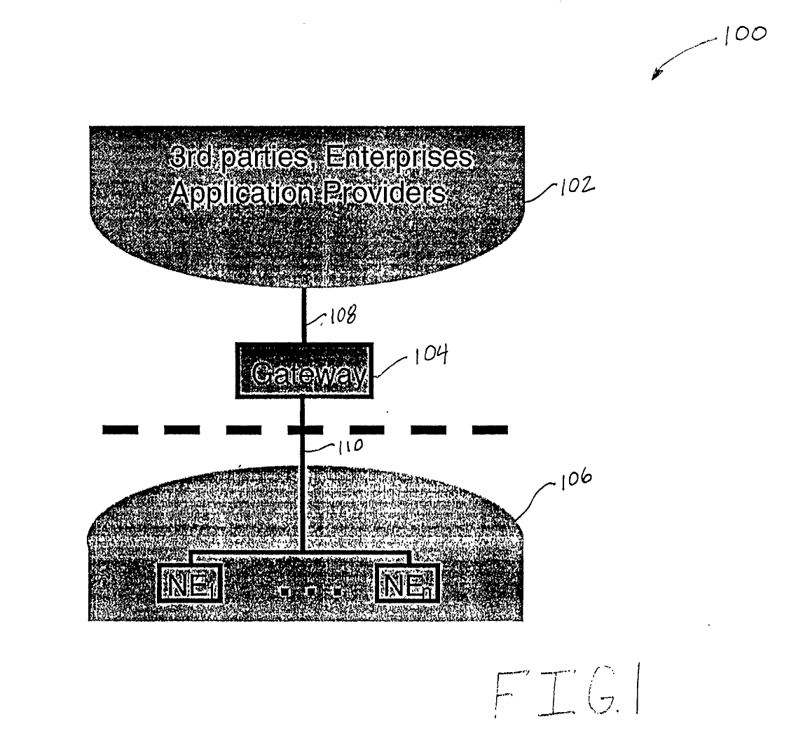

FIG. 2, previously described, is a block diagram of an exemplary architecture including a logical gateway-,

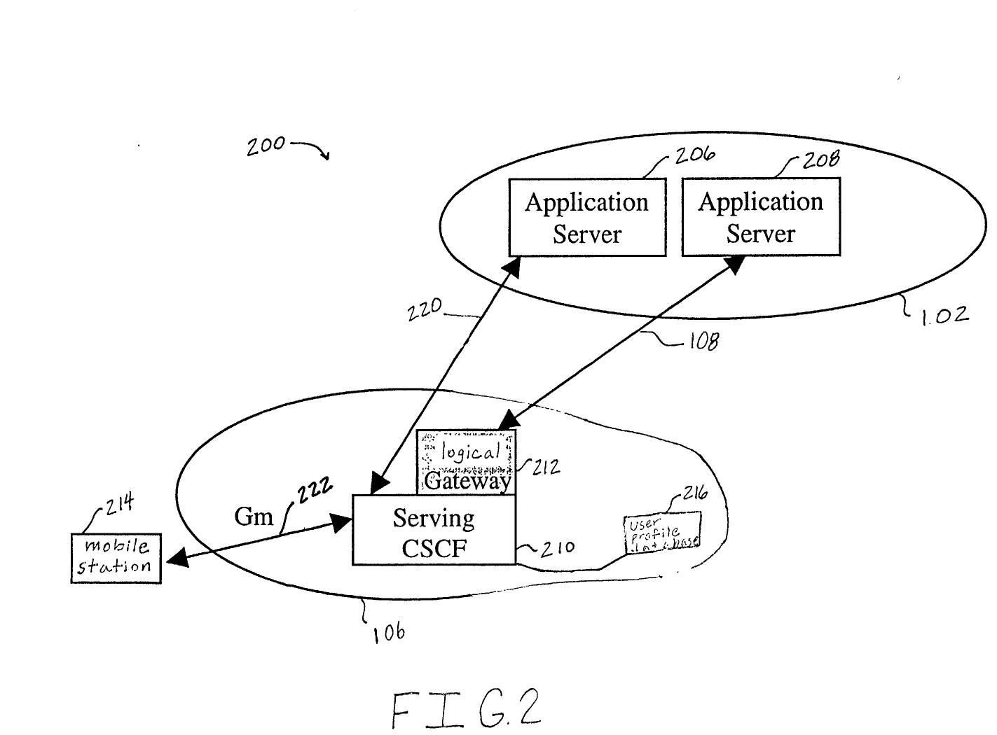

FIG. 3 is a block diagram that illustrates operation of triggers in an exemplary application-programming-interface-based architecture in accordance with the present invention; and

FIG. 4 is a block diagram that illustrates an architecture in which networking-protocol-based and API-based entities are converged in accordance with the present invention.

### DESCRIPTION

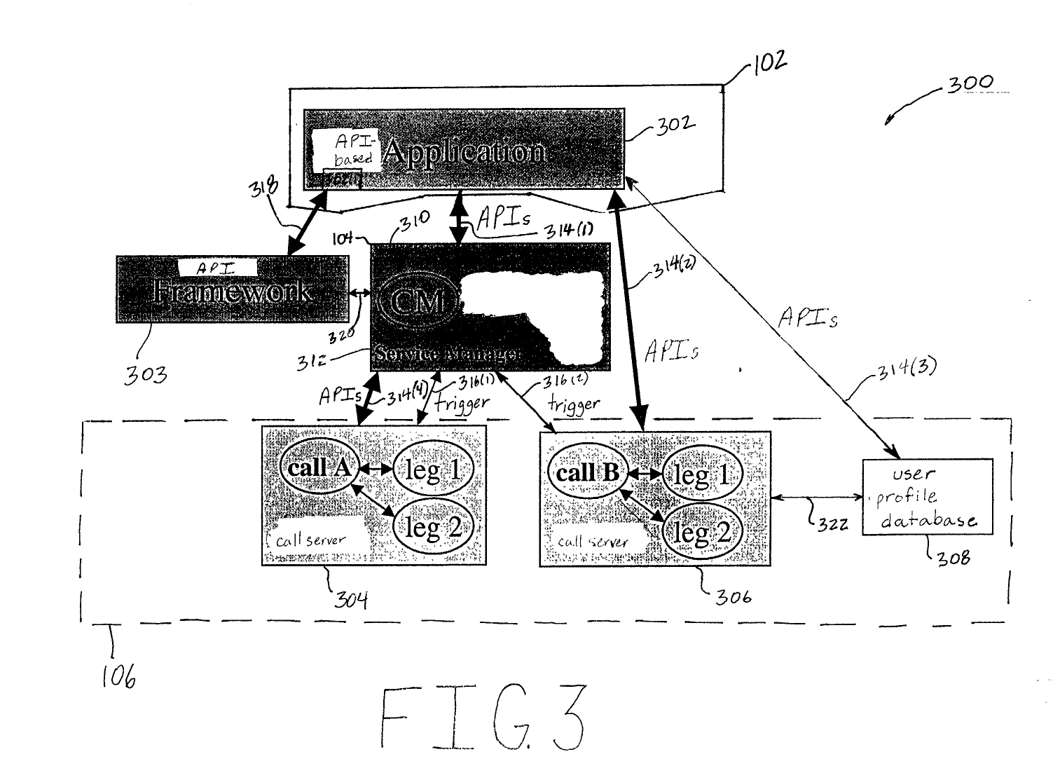

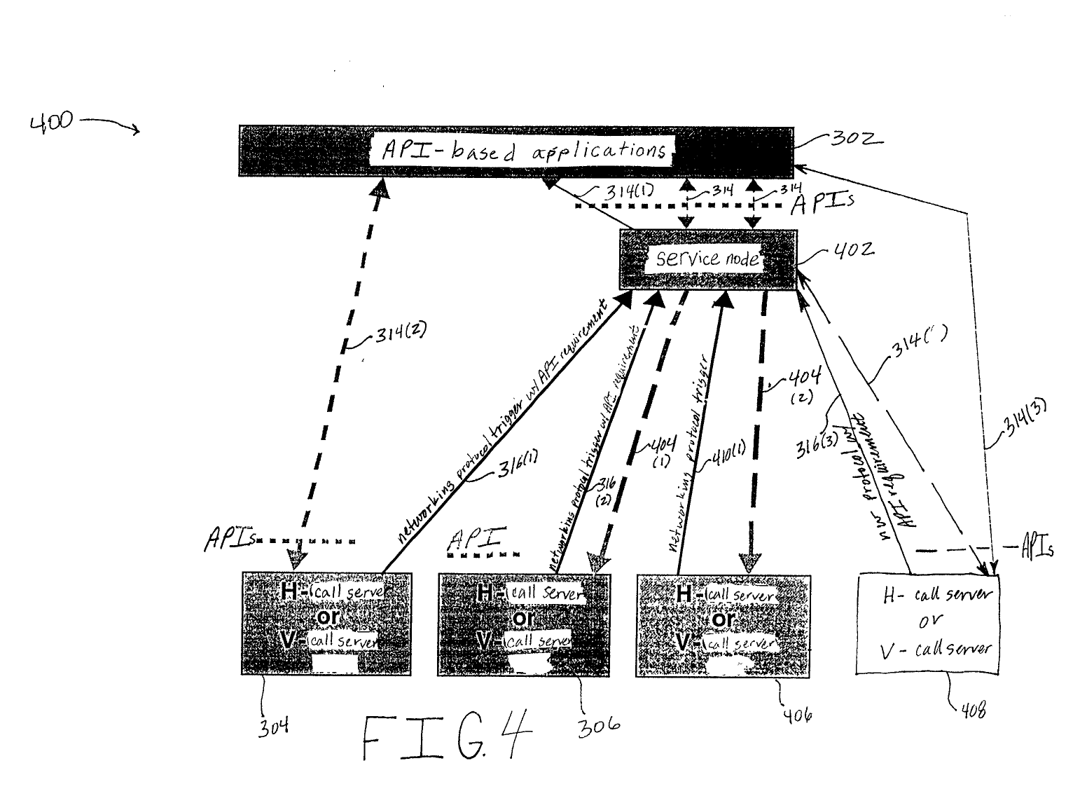

In the following Description, for purposes of explanation and not limitation, specific details are set forth in order to provide a thorough understanding of the present invention. However, it will be apparent to those of ordinary skill in the art that the present invention can be practiced in other embodiments that depart from these specific details. In other instances, detailed descriptions of well-known methods, devices, etc. are omitted so as not to obscure the description of the present invention with unnecessary detail. Preferred embodiments of the present invention and its advantages are best understood by referring to FIGS. 3-4 of the Drawings, like numerals being used for like and corresponding parts of the various Drawings.

Aspects of Parlay and Parlay/OSA, which are both application programming interfaces, will be used to describe preferred embodiments of the present invention. However, it should be understood that the principles of the present invention are applicable to other application-programing-interface-based systems, especially those in which service interaction management among a plurality of applications is necessary or desirable.

Reference is now made to FIG. 3, wherein there is shown a block diagram illustrating operation of triggers in an exemplary application-programming interface-based architecture in accordance with the present invention. An architecture 300 includes API-based applications 302 located in the third party domain 102, the gateway 104, an API framework 303, a call server 304, a call server 306, and a user profile database 308. Within the gateway 104 are a call manager 310 and a service manager 312. Triggers 316(1) and 316(2) are shown between the call server 304 and the call server 306, respectively, and the service manager 312. The call servers 304 and 306 and the user profile database 308 are part of the telecommunications network 106. The gateway 104 and the framework 303 could also be considered to be a part of the network 106 although in FIG. 3 they are depicted outside the network 106. Within the call server 304 is a call A having legs 1 and 2 and in the call server 306 is a call B having legs 1 and 2. Although the present invention is described with reference to the physical gateway 104, it can be practiced with a logical gateway, such as, for example, the logical gateway 212.

The API-based applications 302 communicate with the gateway 104 via APIs 314(1). The API-based applications 302 are shown communicating with the call server 306 and with the user profile database 308 via APIs 314(2) and 314(3), respectively. The APIs 314(4) are used to allow the service manager 312 to communicate with the call server 304. The service manager 312 can also communicate via the APIs 314 with the call server 306; however, the APIs 314 are not explicitly shown between the service manager 312 and the call server 306.

The API-based applications 302 communicate directly with the call server 304, the call server 306, or the user profile database 308 if the service manager 312 has determined that there are no service interaction management issues that would prohibit such direct communication. In contrast, when service interaction management issues are present, the API-based applications 302 communicate with the call server 304, the call server 306, and the user profile database 308 via the service manager 312.

Although the architecture 300 is shown as employing a single set of APIs 314, it will be understood by those of ordinary skill in the art that internal-service APIs and external-service APIs, such as those described in the co-pending United States Patent Application entitled “COMMUNICATION METHOD AM) SYSTEM INCLUDING INTERNAL AND EXTERNAL APPLICATION-PROGRAMMING INTERFACES,” filed concurrently with this application and bearing Attorney Docket No. 27950-484USPT, can be employed in connection with the present invention. When external-service APIs and internal-service APIs are used, the present invention is preferably employed in concert with the internal-service APIs. In the alternative, the present invention can be practiced without the use of internal-service APIs and external-service APIs, but rather with the single set of APIs 314 that are in some respects analogous to the internal-service APIs.

Exemplary operation of the present invention in connection with a particular API-based application 302(1) of the API-based applications 302 will now be described. First, the API-based application 302(1) interacts with the API framework 303 via an interface 318. This interaction includes the application 302(1) making initial contact with the framework 303, the application 302(1) authenticating itself with the framework 303, the framework 303 authenticating itself with the application 302(1), the application 302(1) discovering what services and application-programming interfaces are supported by the network 106, and subscription of the application 302(1) to one or more of those services.

Next, as a result of the subscription by the application 302(1), the framework 303 communicates with the gateway 104 via an interface 320 and retrieves a reference of one or more objects to the call manager 310 in the gateway 104. Next, the gateway 104 creates a call manager object and provides a reference, via the interface 320, of the call manager object to the framework 303. Next, the framework 303 provides this reference to the application 302(1) via the interface 318. From this point forward, the application 302(1) can interact directly with the gateway 104 via the APIs 314(1). The application 302(1) interacts with the gateway 104 using the reference to the call manager 310 provided by the framework 303. The call manager 310 is the primary point of contact between the application 302(1) and the network.

One of the drawbacks to Parlay and OSA as defined in the prior art is the absence of triggers, such as, for example, those defined in networking protocols such as Intelligent Networking (IN), Wireless Intelligent Networking (WIN), and Customized Application of Mobile Enhanced Logic (CAMEL). The triggers 316(1) and 316(2) are API-based triggers that are similar in some respects to networking-protocol triggers. The triggers 316(1) and 316(2) are utilized in the invocation of applications such as the API-based applications 302. An advantage of the API-based triggers 316(1) and 316(2) is that they allow more than one of the API-based applications 302 to subscribe to a given notification. Subscription of more than one of the applications 302 to a given notification is possible in networking protocols such as, for example, IN and CAMEL, but is not possible under Parlay and OSA as defined in the prior art. This is because Parlay and OSA as defined in the prior art require a one-to-one relationship between an application (such as one of the applications 302) and the notification.

Trigger information, including triggering criteria, is placed by a network operator in the user profile database 308, which could be, for example, a Home Subscriber Server (HSS). In the alternative, the user profile database 308 could be a part of a Home Location Register (HLR). When a user registers with the call server 304 or the call server 306, the call server 304 or 306 downloads a user profile corresponding to the user from the user profile database 308. Downloading of such user information is illustrated by the interface 322 between the call server 306 and the database 308.

Each of the triggers 316(1) and 316(2) includes an address of invocation, which defines where the triggers 316(1) and 316(2) should be sent to invoke a given application, such as the application 302(1). The triggers 316(1) and 316(2) are defined by the operator of the network 106.

The triggers 316(1) and 316(2) include information that the network operator perceives may be needed by network entities that receive the triggers 316. For example, the triggers 316(1) and 316(2) could include all of the information that is known in the call server 304 or the call server 306 about an ongoing call or session. Inclusion of this information in the trigger 316(2) from the call server 306 and the trigger 316(1) from the call server 304 helps to minimize network traffic since the information contained therein is available to the service manager 312, which then caches the information for later use if needed rather than communicating with the call server 304 or the call server 306 again once a particular piece of information is needed. Therefore, if, for example, the application 302(1) needs information from the call server 306, it is likely that the needed information has already been cached locally in the service manager 312 and can be accessed there.

Upon the occurrence of an event associated in the user profile database 308 with one or more of the triggers 316(1) or 316(2), the call server 304 and/or the call server 306 sends an appropriate trigger 316(1) or 316(2) to the service manager 312. The service manager 312 handles service interaction management and also can serve as a proxy as described in more detail in the co-pending application entitled “COMMUNICATION METHOD AND SYSTEM INCLUDING INTERNAL AND EXTERNAL APPLICATION-PROGRAMMING INTERFACES” and bearing Docket No. 27950-484USPT.

The triggers 316(1) and 316(2) will typically include the addresses of parties to a call and other information that is relevant to the call. This information is sent to the service manager 312 with the trigger 316(1) or 316(2) so that the service manager 312 can analyze what applications, if any, need to be executed at a particular moment in time in the call. Based on the information in the triggers 316(1) or 316(2), the service manager 312 associates the user to the applications 302 that need to be invoked.

If more than one of the applications 302 has been determined by the service manager 312 to need to be invoked, the service manager 312 will determine how the applications 302 should be invoked and in what sequence and will also analyze any dependencies between the applications 302. After this determination has been made, the service manager 312 invokes the applications 302 in the correct order. In addition to the information about the triggers 316(1) and 316(2) obtained from the user profile database 308, the service manager 312 can also include locally-stored information that is used to perform service interaction management.

In a preferred embodiment, the same APIs are used between the application 302 and the service manager 312 as between the application 302 and network entities, such as, for example, the call server interfaces 304 or 306. As the service manager 312 provides the application 302 with an object reference to be used for service control, the service manager 312 can determine whether to provide a reference to an interface of the service manager 312 or to an interface of the network entity itself In the former situation, the service manager 312 handles service interaction management and proxies communications from the application 302 intended for the network entity to the interface of the network entity itself.

In response to receipt of one or more of the triggers 316(1) and 3 16(2), the service manager 312 communicates with one or more of the applications 302 via the APIs 314(1) and thereby invokes, for example, the application 302(1). Thereafter, depending upon whether there are service interaction management issues, the application 302(1) can communicate directly with, for example, the call server 306 via the APIs 314(2) or can communicate with the service manager 312. When the service manager 312 acts as a proxy, the service manager 312 then communicates with, for example, the call server 304 via the APIs 314(4).

The application 302(1) does not know whether it is communicating with the call server 304 or 306 through a proxy (i.e., the service manager 312) or whether it is communicating directly with the call server 304 or 306. This is possible using a technology such as, for example, Common Object Request Broker Architecture (CORBA), by which the application 302(1) has no information regarding where the interface by which it is communicating resides. In a situation in which no service interaction management issues are present and the API-based application 302(1) speaks directly to the call server 304 or 306 via the APIs 314, this direct communication is made possible by the service manager 312 sending a reference of the interface of the call server 304 or 306 to the application 302(1) so that, in subsequent communications, the APIs 314 can be used directly between the application 302(1) and the call server 304 or 306. The APIs 314(2) is an example of direct communication between the application 302(1) and the call server 306.

It can thus be seen from FIG. 3 that when predetermined criteria occur in a call, a trigger is sent by a call server or other entity to a service manager, which is preferably part of a gateway. The service manager then invokes one or more API-based applications, which can communicate with the call server or other entity directly or via the service manager. API-based triggers allow more than one application to subscribe to a given notification. In response to the trigger, the service manager invokes one or more applications and provides a reference to an object in the service manager or in another entity with which the application can communicate. Depending upon whether there are service interaction management issues, the application then communicates directly with the call server or other entity or communicates via the service manager with the call server or other entity.

Reference is now made to FIG. 4, wherein there is shown a block diagram illustrating an architecture 400 in which networking-protocol-based and API-based entities are converged in accordance with the present invention. The use of API-based triggers for invocation of applications and association of users with a given call server permits convergence of existing networking-protocol-based network entities with API-based network entities. Because networking-protocol-based networks use protocols, such as, for example, IN, WIN, and CAMEL, utilize triggers, API-based triggers, such as, for example, those described with respect to FIG. 3, can be developed in accordance with the present invention so that convergence of networking-protocol-based networks and API-based networks can be achieved provided that a similar call model and triggers are used.

FIG. 4 shows the API-based applications 302, a service node 402 capable of communicating via a networking protocol 404 or via the APIs 314, the call servers 304 and 306, and call servers 406 and 408. Each of the call servers 304, 306, 406, and 408 can be a home call server or a visited call server, meaning that the call server 304, 306, 406, and 408 is either in the user's home network or, alternatively, is in a visited network of the user.

The service node 402, in addition to being able to communicate with the call servers 304, 306, 406, and 408, can also communicate via the APIs 314 with the API-based applications 302. In accordance with the present invention, either networking-protocol services or API-based services can be accessed using a trigger. It is assumed for the purposes of FIG. 4 that API-based and networking protocol triggers are compatible with one another by virtue of a similar call model and trigger characteristics. Of course, this need not be the case if convergence is not an issue, as in FIG. 3. A given call server can send a trigger to the service node 402 that includes an API-based requirement or not.

Operation of these triggers will now be described. The call server 304 can communicate via the API-based trigger 316(1), which in FIG. 4 is a networking-protocol trigger with an API requirement (i.e., an API-based trigger) or via a networking-protocol trigger without an API requirement 404, only the former being shown with respect to the call server 304. Upon the occurrence of a predetermined call event, the call server 304 sends the API-based trigger 316(1) to the service node 402. In response to the API-based trigger 316(1), the service node 402 communicates with the API-based applications 302 via the APIs 314(1). In response to this communication, the API-based applications 302 communicate directly with the call server 304 via the APIs 314(2). The call server 304 requested that it be allowed to use the APIs 314, the request was granted by the service node 402, the service node 402 communicated the request of the call server 304 to the API-based applications 302, and the API-based applications 302 initiated communications directly with the call server 304 via the API 314(2).

The call server 306 issues a networking-protocol trigger with an API requirement 316(2) to the service node 402. However, the service node 402 does not permit the call server 306 to use the APIs 3 14. Therefore, the service node 402 responds to the call server 306 directly using a networking protocol message 404(1). There could be various reasons why a request by the call server 306 to use the APIs 314 would be denied by the service node 402. For example, certain types of calls or certain categories of users could be prohibited from using the APIs 314. In addition, the call servers 304, 306, 406, and 408 could be able to determine under what circumstances they would use the networking protocol 404 and under what circumstances they would use the APIs 314, such as, for example, use of the APIs 314 for Internet protocol-based multimedia services and use of the networking protocol 404 for traditional voice services.

The call server 406 sends a networking protocol trigger without an API requirement 410(1) to the service node 402. The service node 402 responds to the call server 306 via a network protocol message 404(2). It could be that the call server 406 does not have the capability to use the APIs 314 or that, under the particular circumstances of the call for which the trigger 410(1) was sent, the call server does not want to use the APIs 314.

The call server 408 communicates with the service node 402 by sending the API-based trigger 316(3) to the service node 402. In this circumstance, the service node 402 communicates directly with the call server 408 using the APIs 314(4). Thereafter, the API-based applications 302 can communicate with the call server 408 via the APIs 314(3).

In a preferred embodiment of the present invention, the service node is an IN service control point (SCP), the call servers are IP multimedia call servers operating according to OSA, and the API-based applications operate according to Parlay. However, it will be apparent to persons of ordinary skill in the art that other protocols and API-based solutions could be used with the present invention.

It can thus be seen from FIG. 4 that incorporation of an API requirement into a networking-protocol trigger permits convergence of networking-protocol-based entities with API-based entities, so long as the two types of triggers are compatible with one another. The entity sending the trigger and/or the entity receiving the trigger can determine whether the networking protocol or the APIs will be used for further communications.

What is claimed is:

1. A method of providing telecommunications services comprising the steps of:
sending by a call server of a first trigger linked to a first call event to a service manager in response to occurrence of the first call event;
sending by the call server of a second trigger linked to a second call event to the service manager in response to occurrence of the second call event;
in response to receipt of the first and the second triggers, the service manager performing a service interaction management analysis and determining which applications should be executed; and
in response to a determination that at least one application should be executed, invoking by the service manager of the at least one application via an application-programming interface.

2. The method of claim 1 wherein the step of invoking further comprises providing to the at least one application information regarding an object with which the at least one application must interact.

3. The method of claim 2 further comprising the step of interacting by the at least one application directly with the call server via the application-programming interface.

4. The method of claim 3 wherein the application-programming interface comprises Open Service Access (OSA).

5. The method of claim 4 wherein the step of interacting directly with the call server is responsive to a determination that no service interaction management issues are present.

6. The method of claim 2 further comprising the step of interacting by the at least one application with the service manager via the application-programming interface.

7. The method of claim 6 wherein the application-programming interface comprises Open Service Access (OSA).

8. The method of claim 7 further comprising the step of interacting by the service manager via the application-programming interface with the call server, the service manager serving as a proxy.

9. The method of claim 1 further comprising caching by the service manager of call-related information included in the triggers.

10. The method of claim 9 further comprising the step of proxying by the service manager between the at least one application and the call server.

11. The method of claim 1 wherein the triggers comprise intelligent-networking (IN) triggers.

12. The method of claim 11 wherein at least one of the triggers comprises an Open Service Access (OSA) requirement.

13. The method of claim 12 wherein the OSA requirement includes a reference to a call object on the call server.

14. The method of claim 1 further comprising the step of obtaining by the call server of a plurality of trigger criteria from a user profile database.

15. The method of claim 14 wherein the triggers permit dynamic association of the call server to a particular user.

16. The method of claim 1 wherein the first call event and the second call event are the same event.

17. An application-programming-interface-based telecommunications system comprising:
a call server obtaining criteria corresponding to at least one trigger from a user profile database and, in response to occurrence of the criteria, sending the at least one trigger;
a service manager receiving the at least one trigger and, in response to receipt of the at least one trigger, performing a service interaction management analysis and determining in what manner applications should be executed;
an application-programming interface adapted to permit the call server, the service manager, and the applications to communicate; and
at least one application being invoked in response to a communication from the service manager via the application-programming-interface.

18. The system of claim 17 wherein the application-programming interface comprises Open Service Access (OSA).

19. The system of claim 17 wherein the service manager serves as a proxy between the first call server and the at least one application.

20. The system of claim 17 wherein the service manager directs the at least one application to interact directly with the call server.

21. The method of claim 17 wherein the service manager caches call-related information included in the at least one trigger.

22. The system of claim 17 wherein the at least one trigger comprises intelligent-networking (IN) triggers.

23. The system of claim 22 wherein the at least one trigger comprises an Open Service Access (OSA) requirement.

24. The system of claim 22 wherein the OSA requirement includes a reference to a object on the call server.

25. A telecommunications system comprising:
a service node adapted to communicate according to pre-determined criteria via an application-programming interface (API) with at least one application or via a networking protocol; and
at least one network entity adapted to send to the service node a networking protocol trigger that includes an API requirement, the API requirement requesting an API response to the trigger, wherein the service node is adapted to, depending on the pre-determined criteria, respond to the network entity according to the networking protocol or to communicate with the at least one application via the API.

26. The system of claim 25 wherein the service node is adapted to respond to the network entity via the API.

27. The system of claim 25 wherein the at least one application communicates directly with the network entity via the API in response to the communication by the service node to the at least one application.

28. The system of claim 25 wherein the networking protocol comprises the intelligent-networking (IN) protocol.

29. The system of claim 28 wherein the API requirement comprises an Open Service Access (OSA) requirement.

30. The system of claim 29 wherein the OSA requirement includes information regarding an object with which the at least one application must interact.

31. The system of claim 28 wherein the service node comprises a service control point (SCP).

32. A method of converging telecommunication systems comprising:
sending by at least one network entity to a service node a networking protocol trigger that includes an application-programming interface (API) requirement, the API requirement requesting an API response to the trigger; and
depending on pre-determined criteria, responding by the service node to the network entity according to the networking protocol or communicating by the service node with at least one application or with the network entity via the application-programming interface (API).

33. The method of claim 32 further comprising the step of communicating by the at least one application directly with the network entity via the API in response to the step of communicating by the service node with the at least one application.

34. The method of claim 32 wherein the networking protocol comprises the intelligent-networking (IN) protocol.

35. The method of claim 34 wherein the API requirement comprises an Open Service Access (OSA) requirement.

36. The method of claim 35 wherein the OSA requirement includes information regarding an object with which the at least one application must interact.

37. The method of claim 34 wherein the service node comprises a service control point (SCP).
